(19) United States
(12) Patent Application Publication
(10) Pub. No.: US 2008/0143781 A1
(43) Pub. Date: Jun. 19, 2008

(54) INKJET PRINTING APPARATUS AND CONTROL METHOD FOR INKJET PRINTING APPARATUS

(75) Inventors: Kouji Inoue, Tokyo (JP); Yasuyuki Tamura, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/953,984

(22) Filed: Dec. 11, 2007

(30) Foreign Application Priority Data
Dec. 15, 2006 (JP) 2006-338697

(51) Int. Cl. B41J 2/165

(52) U.S. Cl. 347/34

(57) ABSTRACT

The objective of the present invention is to provide an inkjet printing apparatus that can reduce the scattering or floating, through the main body of the printing apparatus, of ink mist generated during pre-ejection. To achieve this objective, according to this invention, after a printing unit has completed ink ejection relative to an ink receiving member, and before the printing unit is moved from the position opposite the ink receiving member, an ink mist suction operation is started.

### BACKGROUND OF THE INVENTION

1. Field of the Invention

The present invention relates to an inkjet printing apparatus that ejects ink droplets through a printing unit to print on a printing medium, and a control method for the inkjet printing apparatus.

2. Description of the Related Art

Conventionally, an inkjet printing apparatus includes recovery means provided to maintain the reliability with which ink is ejected by a print head. This recovery means, as constituted, mainly provides four functions: wiping, suction recovery, capping and pre-ejection.

Wiping is a cleaning operation performed for a print head face (the ink ejection face, in which ejection orifices of print head are formed) by using a elastic member, a blade composed of a material such as rubber, to wipe the ink ejection face and remove ink and foreign substances such as paper lint.

Suction recovery is a cleaning operation performed to maintain a normal ejection function when a foreign substance can not be cleaned from the ink ejection face by wiping, or when nozzles are clogged with ink, by using a suction pump to remove the foreign substance, or the ink.

Capping is a process performed for a print head that is not used for ejection of ink for an extended period of time, and is intended to prevent malfunctions, such as defective ejection caused by evaporation and the drying of ink in nozzles, by excluding the possibility that the nozzles will become clogged with viscous or solidified ink. That is, during a non-printing period, the capping process is performed to cover the ink ejection face of a print head and prevent ink in the nozzles of the print head from becoming thickened or solidified through evaporation or drying.

Further, when the ink ejection process is not to be continued, but the ink ejection face is exposed and not capped, ink in the nozzles may become thickened through solvent evaporation, and the ejection function or the quality of a printed image degraded. Therefore, at a specific time interval or at the start or end of a printing operation, regardless of the print data that are used, ink ejection is performed in a predetermined place (an ink receiving member) outside a printing medium. This ink ejection operation is generally called pre-ejection. Through this operation, thickened ink in the nozzle can be replaced with fresh ink, appropriate for printing, and an improvement in the ejection function of the print head can be obtained.

When the inkjet printing apparatus ejects ink, fine ink droplets (hereinafter referred to as a mist or an ink mist) may be formed in addition to the regular ink droplets, or a mist may be generated by the splashing of ink droplets ejected onto a printing medium. Such an ink mist, when suspended and floating through the printing apparatus, can become attached to the ink ejection face of the print head and thus deteriorate the ejection function, or can become attached to the conveying system of the printing apparatus and smear printing media. Hereinafter, this problem is called a floating mist problem. The floating mist problem may also be the result of mist produced by the above described pre-ejection process.

As a countermeasure for the floating mist problem, a technique is disclosed in Japanese Patent Laid-Open No. 2002-307725. According to the technique in Japanese Patent Laid-Open No. 2002-307725, a fan is arranged in a printing apparatus, and an air stream generated by this fan is employed to collect ink mist afloat in the printing apparatus.

Furthermore, a preventive attempt wherein a shutter is provided for a pre-ejection receiving member which receives ink ejected by the pre-ejection operation is disclosed in Japanese Patent Laid-Open No. 11-342636 (1999). According to this disclosure, the shutter is kept closed at all times except during a pre-ejection operation, so that an ink mist occurring during pre-ejection is closed off and is retained in the pre-ejection receiving member.

Since the technique disclosed in Japanese Patent Laid-Open No. 2002-307725 collects not only ink mist that is generated during pre-ejection, but also ink mist that occur during the printing of a printing medium, satisfactory ink mist collection efficiency can be obtained. However, since a large fan must be constantly driven in order to collect both the mist occurring during printing and the mist occurring during pre-ejection, and since the fan, when so driven, generates a great amount of noise, the use environment is deteriorated.

In Japanese Patent Laid-Open No. 11-342636 (1999), of the pre-ejected droplets, droplets having small sizes or droplets having slow flying speeds form a floating mist adrift near the ink ejection face. Thus, this ink mist can not be closed off and retained inside the pre-ejection receiving member by the shutter, and an appropriate mist collection effect can not be attained. In addition, there is a chance that an air stream, produced by the closing or the opening of the shutter, may cause mist adrift near the shutter to be spread throughout a printing apparatus.

### SUMMARY OF THE INVENTION

One objective of the present invention is to provide an inkjet printing apparatus that can reduce the spreading, or the floating, throughout an inkjet printing apparatus of an ink mist that occurs during pre-ejection.

In order to achieve this objective, the present invention employs the following configurations.

According to a first aspect of the present invention, an inkjet printing apparatus, which reciprocally supports a printing unit and which, to perform printing, permits the printing unit to eject ink onto a printing area where a printing medium is held, comprises: an ink receiving member for accepting, at a position not opposite the printing area, ink that is ejected by the printing unit; and a suction unit for drawing in air, using suction, from an area surrounding the ink receiving member, and discharging air so accumulated into the ink receiving member, wherein the suction unit begins a suction operation within a period following the start, by the printing unit, of an ink ejection operation for the ink receiving member, until the start of moving the printing unit from the ink receiving member.

According to a second aspect of the invention, a control method, for an inkjet printing apparatus that reciprocally supports a printing unit and, to perform printing, permits the printing unit to eject ink onto a printing area where a printing medium is held, comprises the steps of: providing an ink receiving member that accepts, at a position not opposite the printing area, ink that is ejected by the printing unit; and within a period following the start of an ink ejection operation, by the printing unit, for the ink receiving member until the start of moving the printing unit from the ink receiving member, beginning an operation for drawing in air surrounding the ink receiving member, and collecting, in the ink receiving member, an ink mist generated around the ink receiving member due to the ink ejection operation.

In this invention, during a period before the printing unit that has ejected ink begins to move away from the ink receiving member, an ink mist that is floating in the air around the ink receiving member is drawn into the ink receiving member together with the air by suction. Thus, even when an ink mist is generated through the ejection of ink to the ink receiving member, spreading of the ink mist into the printing apparatus by an air stream generated by the movement of the print head can be reduced. As a result, damage to the apparatus by the ink mist can be reduced.

Further, since the mist suction operation is performed only after ink ejection relative to the ink receiving member has been performed, noise that accompanies the suction operation can be reduced. In addition, mist generated during the ejection of ink into the ink receiving member can be effectively collected.

Further features of the present invention will become apparent from the following description of exemplary embodiments (with reference to the attached drawings).

### BRIEF DESCRIPTION OF THE DRAWINGS

FIG. 1 is a perspective view of the entire inkjet printing apparatus for which the present invention can be applied;

FIG. 2 is a bottom perspective view of a print head cartridge and a carriage shown in FIG. 1;

FIG. 3 is a schematic block diagram illustrating the arrangement of the control system of the inkjet printing apparatus in FIG. 1;

FIG. 4 is an X-Z cross sectional view of an ink receiving member according to a first embodiment of the present invention;

FIG. 5A is an X-Z cross-sectional view of the state of an ink mist that occurs near an ink receiving opening during the pre-ejection in the first embodiment;

FIG. 5B is an X-Z cross-sectional view of the state of an ink mist that occurs, in the first embodiment, when the carriage is moved without a mist suction pump being operated;

FIG. 6 is an X-Z cross sectional view of an ink receiving member according to a second embodiment of the present invention;

FIG. 7A is an X-Z cross sectional view for explaining the operation of the ink receiving member in FIG. 6 and showing the pre-ejection during printing;

FIG. 7B is an X-Z cross sectional view for explaining the operation of the ink receiving member in FIG. 6 and showing the state wherein a print head is moved without moving a movable portion;

FIG. 7C is an X-Z cross sectional view for explaining the operation of the receiving member in FIG. 6 and showing the state wherein the pre-ejection during printing has been ended and the movable portion is moved;

FIG. 8 is an X-Z cross sectional view of the ink receiving member of the second embodiment of the present invention, showing the state wherein pre-ejection is performed by inclining the movable portion; and

FIG. 9 is an X-Z cross sectional view of an ink receiving member according to a third embodiment of the present invention.

### DESCRIPTION OF THE EMBODIMENTS

The preferred embodiments of the present invention will now be described in detail while referring to the accompanying drawings.

### First Embodiment

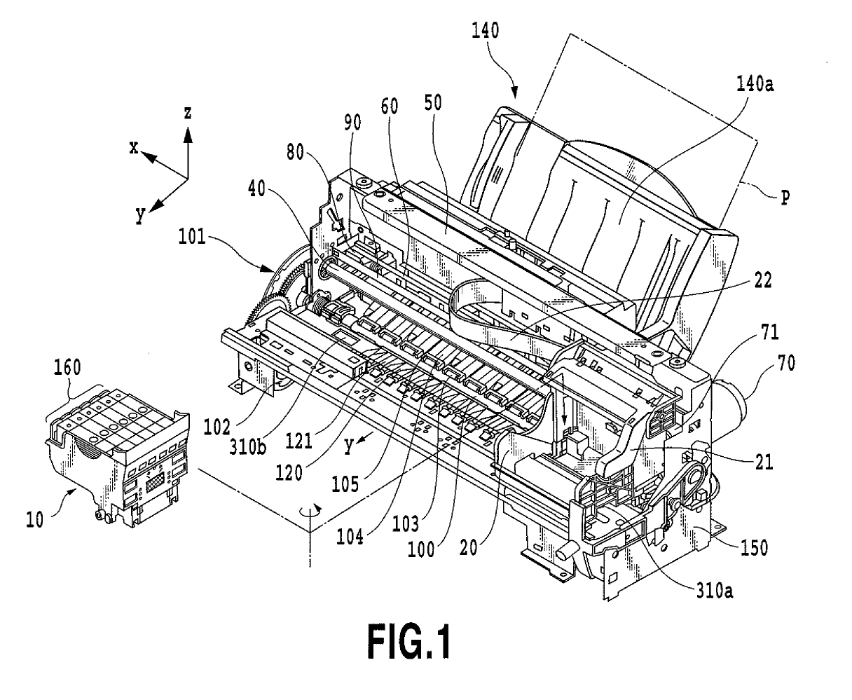

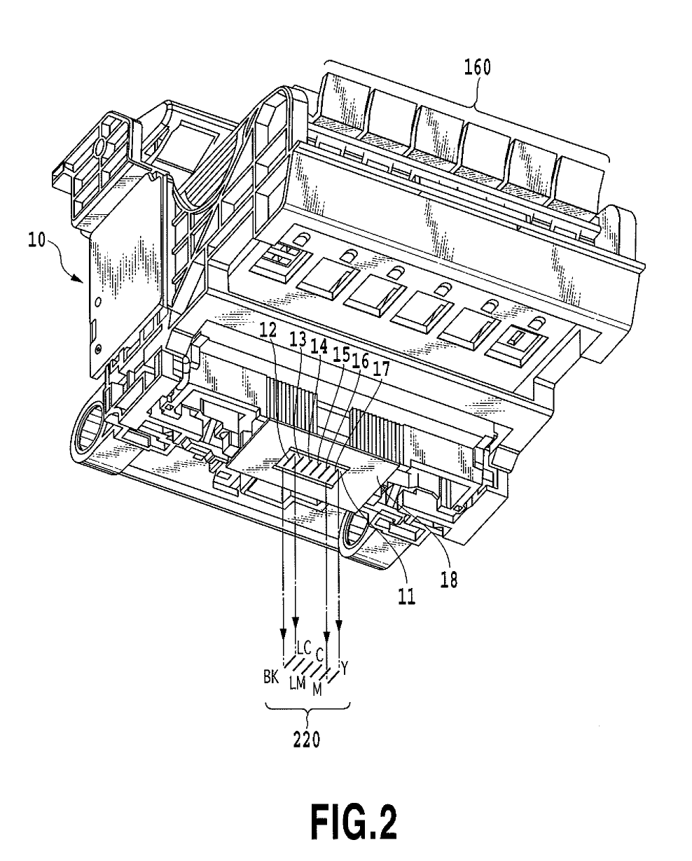

FIG. 1 is a perspective view of the entire inkjet printing apparatus (without a case) for which the present invention can be applied. FIG. 2 is an enlarged bottom perspective view of a print head cartridge in FIG. 1.

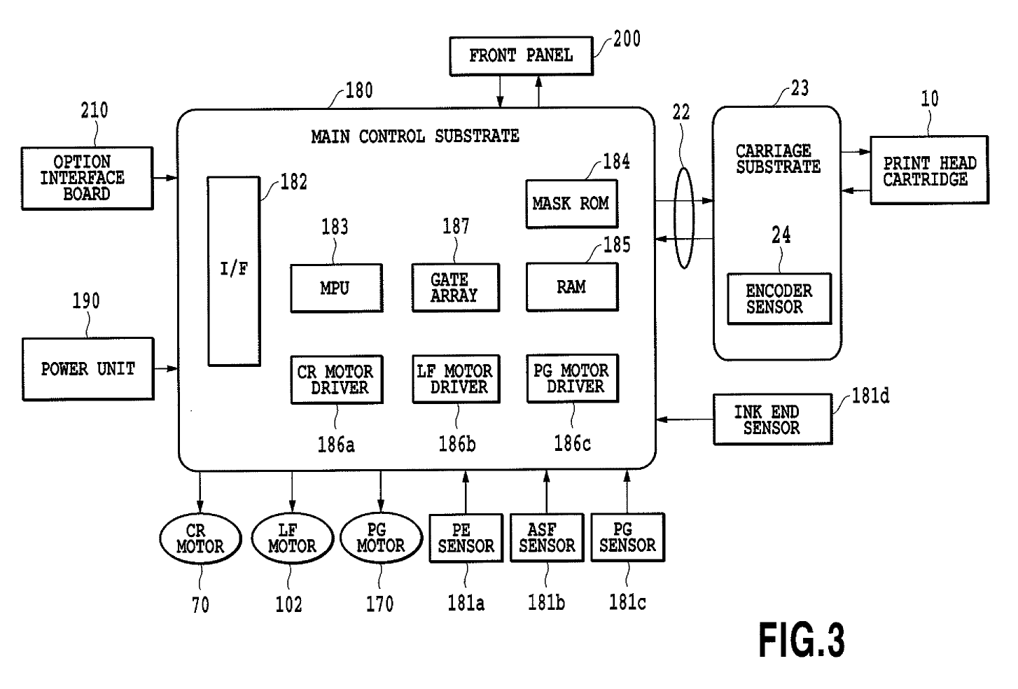

While referring to FIG. 1, for an inkjet printing apparatus 1, a carriage 20, on which a print head 10 can be mounted, is supported by a guide shaft 40 and a guide rail 50 that are fixed to a chassis 150 so they reciprocally move in the X direction (the main scanning direction). The print head 10 includes: a print element substrate 11 (see FIGS. 2 and 3), on which a plurality of nozzles are formed to eject inks of a plurality of colors; and a tank mounting portion, which detachably holds an ink tank 160 wherein ink is retained for supply to the individual nozzles of the print element substrate 11. Further, the print head 10 is detachable from the carriage 20, and is a so-called cartridge type print head. A removal lever 21 is used to attach and remove the print head 10 relative to the carriage 20.

The reciprocal movement of the carriage 20 is performed by the driving force of a CR motor (carriage motor) 70. That is, a drive belt 60 is extended between a motor pulley 71 and an idler pulley 80 that are fixed to the motor shaft of the CR motor 70, and the carriage 20 is secured to the drive belt 60. Therefore, when the CR motor 70 is driven to forward or reversely rotate the motor pulley 71, the drive belt 60 moves in the forward direction or in the reverse direction. Accordingly, the carriage 20 moves forward or backward. During this reciprocal movement of the carriage 20, an encoder sensor 24 (see FIG. 3) that is mounted on the carriage 20 reads an encoder scale 90, so that the position of the carriage 20 can be detected while moving.

In addition, an area (hereinafter also called a “printing area”) through which a printing sheet (printing medium) P is passed is formed below the carriage 20 in FIG. 1. At the position (to the right, beyond the printing area in FIG. 1) outside the printing area, a recovery device (not shown) is located in order to maintain an appropriate ink ejection state for the print head 10. The recovery device has a suction recovery mechanism that includes: a cap (not shown) for tightly closing an ink ejection face (the face wherein the ink ejection orifices are formed) 18 of the print head 10; and a pump that generates a negative pressure to be introduced into the cap. This suction recovery mechanism tightly covers the ink ejection face with the cap, generates a negative pressure in the cap using the pump, then forcibly absorbs ink, under negative pressure, through ink ejection orifices 12 to 17 (see FIG. 2) of the print head 10 and discharges the ink. In addition, a wiping mechanism (not shown) that employs a elastic member (a wiper) to wipe the ink ejection face 18 of the print head 10 is provided as means for recovering the ejection function of the print head 10.

On the other hand, the printing sheets P, on which an image is to be printed by the print head 10, are stacked on a sheet tray 140a of an auto sheet feeder (ASF) 140. The printing sheets P stacked on the sheet tray 140a are fed one by one, by feed rollers (not shown) provided for the ASF 140, between a conveying roller 100 and a pinch roller 103 located inside the main body of the printing apparatus. The conveying roller 100 is intermittently rotated a predetermined distance by the driving force of the motor of the print head 10, and conveys the printing sheet P in the Y direction (sub-scanning direction). The rotation of the conveying roller 100 is performed by transmitting the driving force of an LF motor (a line feed motor) via a drive force transmission unit 101, formed of a gear train, to the conveying roller 100.

Furthermore, in FIG. 1, a platen 120 supports the printing sheet P. This platen 120 is positioned opposite the ink ejection face 18 of the print head 10 that is mounted on the carriage 20. A plurality of ribs 121 are formed on the face of the platen 120 opposite the print head 10. The ribs 121 support the reverse face of the printing sheet P to substantially maintain a constant distance between the printing sheet P and the ink ejection face 18 of the print head 10. It should be noted that the maximum area where the platen 120 supports the printing sheet P is employed as the above described printing area.

In addition, openings 310a (right) and 310b (left) for receiving ink ejected from print head during pre-ejection operation are formed in the platen 120 on either side of the printing area. The ink ejection operation (pre-ejection) of the print head 10 is to be performed toward the openings 310a and 310b. In the following explanation, the openings 310a and 310b for pre-ejection are called ink receiving openings. In this embodiment, as pre-ejection operations, the inkjet printing apparatus performs pre-ejection during printing and pre-ejection prior to printing.

The pre-ejection during printing is a pre-ejection operation performed when the carriage 20 is reciprocally moved during the printing sequence performed relative to the printing sheet P. Specifically, during the printing operation, the carriage 20 is moved to the ink receiving opening 310a or 310b at a predesignated time, and during this movement of the carriage 20, ink ejection is repeated several tens of times for each nozzle.

The pre-ejection prior to printing is a pre-ejection operation performed before the printing sequence performed relative to the printing sheet P is started. For this pre-ejection, the carriage 20 is halted above the ink receiving opening 310a, and ink ejection is performed about 1000 times for each nozzle.

In the inkjet printing apparatus of this embodiment having the above arrangement, the printing sheet P set to the ASF 140 is conveyed to the platen 120 by the feed rollers, the conveying roller 100 and the pinch roller 103. Then, moving in the X direction of the carriage 20, where the print head 10 is mounted (main scanning), and intermittent moving of the printing sheet P in the Y direction, that intersects the main scanning direction (sub-scanning), are repeated. As a result, an image is formed on the printing sheet P.

As shown in FIG. 2, on the print element substrate 11 of the print head 10, the nozzles 12 to 17 are formed in order to eject a plurality of ink types. The nozzle 12 is for ejection of black ink (Bk), the nozzle 13 is for ejection of light cyan ink (Lc), the nozzle 14 is for ejection of light magenta ink (LM), the nozzle 15 is for ejection of cyan ink (C), the nozzle 16 is for ejection of magenta ink (M), and the nozzle 17 is for ejection of yellow ink (Y). In this embodiment, full color printing is enabled using the ink ejected through these nozzles 12 to 17. An example ink ejection method using the nozzles 12 to 17 can be a method employing an electrothermal conversion member (heater) that generates thermal energy for ink ejection. According to this method, heat generated by the electrothermal conversion member to cause film boiling of the ink inside the nozzles, and the obtained bubble energy is employed to eject ink droplets through the ink ejection orifices.

FIG. 3 is a schematic block diagram illustrating the arrangement of the control system of the inkjet printing apparatus for this embodiment.

The inkjet printing apparatus includes not only the CR motor 70, which moves the carriage 20 in the main scanning direction, and the LF motor 102, which conveys the printing sheet P in the sub-scanning direction, but also a PG motor (also serving as a feed motor) 170, which drives the recovery device to maintain a satisfactory ink ejection function for the print head 10, and which drives a mechanism that feeds the printing sheet P stacked on the ASF 140 until it reaches the printing area.

In addition, a main control substrate 180 is provided as a controller that not only drives the motor and the print head 10, but also controls the individual sections. The main control substrate 180 is connected to a carriage substrate 23 by a carriage FFC (flexible flat cable) 22 shown in FIG. 1. Further, a power unit 190 and an operation front panel 200 are connected to the main control substrate 180, while an option interface board 210 is also connected as needed. Furthermore, various sensors are connected to the main control substrate 180. These sensors are, for example, a paper end sensor 181a for detecting the edge of the printing sheet P, a home position sensor 181b for the auto sheet feeder 140, a home position sensor 181c for the recovery device and an ink end sensor 181d for the ink tank 160.

An interface circuit 182 is provided for the main control substrate 180 to communicate with an external host, such as a host computer or a scanner. The main control substrate 180 also includes an MPU 183, which is a microprocessor that controls the individual sections, a mask ROM 184, in which a control program executed by the MPU 183 is stored, and a RAM 185, in which print data are temporarily stored. Furthermore, drivers are provided for the main control substrate 180 to drive the individual motors in accordance with instructions issued by the MPU 183. That is, in FIG. 3, a CR motor driver 186a drives the CR motor 70, an LF motor driver 186b drives the LF motor 102, and a PG motor driver 186c drives the PG motor 170. A gate array 187 is used to interconnect the above described circuits and components.

The MPU 183 is connected via the interface circuit 182 to a host, such a host computer or a scanner, and performs a printing operation based on a control program stored in the mask ROM 184. That is, based on print data received from the host and stored in the RAM 185, the MPU 183 controls the CR motor 71, the LF motor 102 and the PG motor 170, and also controls the print head 10 via a head driver. In addition, in accordance with the control program, the MPU 183 permits the print head 10 to perform the pre-ejection operation for the ink receiving opening 310a or 310b.

A display element (not shown) using a dip switch, a key switch or a light-emitting diode is provided for the front panel 200. The print head 10 is detachably mounted on the carriage 20, and the encoder sensor 24 is provided to detect the position of the carriage 20.

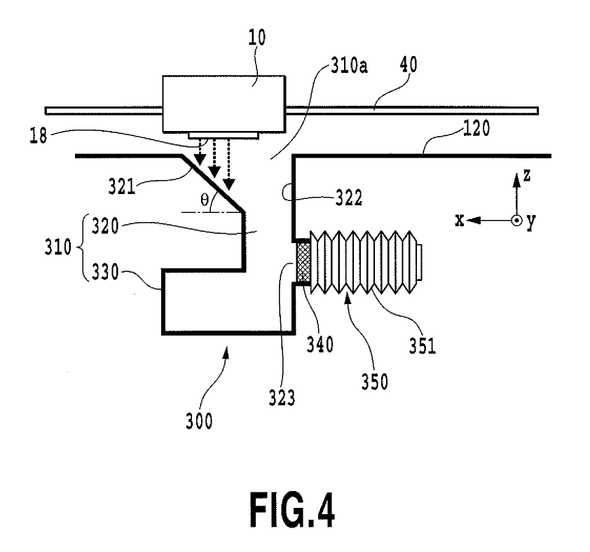

FIG. 4 is an X-Z cross sectional view of the structure of an ink receiving member according to this embodiment. In this embodiment, ink receiving members 300 for receiving ink are prepared in consonance with the two ink receiving openings 310a and 310b that are formed in the platen 20. Since the same structure is employed for the ink receiving members 300, except that they are formed symmetrically along the Y-Z plane, the structure of the ink receiving member 300 correlated with the ink receiving opening 310a will now be described.

For this embodiment, an ink collecting portion 310, where the ink receiving opening 310a serves as an opening, is formed for the ink receiving member 300. The ink collecting portion 310 includes: a mist guiding portion 320 that communicates with the ink receiving opening 310a, and a waste ink tank 330 that communicates with the lower end of the mist guiding portion 320. An ink receiving face 321 is formed on the mist guiding portion 320, and is inclined obliquely downward from the opening to the middle of the mist guiding portion 320. As shown in FIG. 4, when the print head 10 is halted at the pre-ejection position, the ink receiving face 321 is located opposite each ink ejection orifice of the ink ejection face 18 that serves as the ink ejection orifice of the print head 10. In this embodiment, the ink receiving face 321 is formed at an angle of θ=50° relative to the horizontal plane.

Furthermore, in the mist guiding portion 320, a discharge port 323 is formed in a face 322 opposite the side where the ink receiving face 321 is formed. Further, a mist removal filter 340 is provided inside the discharge port 323, and a mist suction pump 350 (suction means) is connected to the outer end of the discharge port 323. The mist suction pump 350 draws air into the mist guiding portion 320 by suction, and discharges the air into the outside. This operation is controlled by the MPU 180.

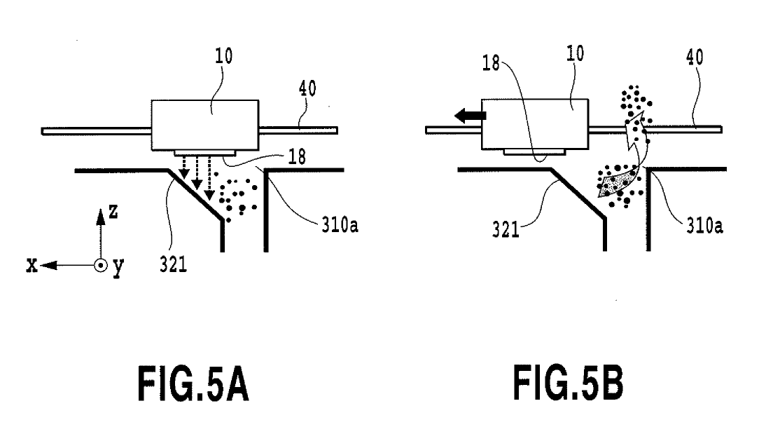

FIGS. 5A and 5B are diagrams showing the state of the inside of the ink receiving opening 310a when the pre-ejection is performed for the ink receiving member 300 having the above described arrangement, without operating the mist suction pump 350. In this case, when pre-ejection is performed toward the ink receiving face 321, ink droplets having large sizes land on the ink receiving face 321. The ink droplets that have landed on the ink receiving face 321 flow down to the wall of the mist guiding portion 320 along the slope of the ink receiving face 321, and are retained in the waste ink tank 330.

On the other hand, of the ink droplets generated during pre-ejection, small ink droplets can not land on the ink receiving face 321 because of air resistance, and drift as an ink mist around the ink receiving opening 310a at the mist guiding portion 320 (see FIG. 5A). When pre-ejection is ended, the carriage 20 and the print head 10 are moved from above the ink receiving opening 310a to perform the printing operation. As the carriage 20 is moved, an air flow is generated, and as shown in FIG. 5B, the ink mist that has drifted in the ink receiving opening 310a is scattered inside the main body of the printing apparatus, and is attached to the ink ejection face of the print head 10 and the internal structure.

In this embodiment, therefore, in synchronization with the time at which the pre-ejection is ended and the carriage 20 is moved, the mist suction pump 350 is driven to collect ink mist. That is, during a period after pre-ejection is terminated until the carriage 20 starts moving away from above the ink receiving opening 310a, the mist suction pump 350 is driven and draws air into the mist guiding portion 320. Through this suction operation, air outside the ink receiving member 320, especially ink mist that is floating around the ink receiving opening 310a (around the ink receiving member 320), is led to the ink collecting portion 310 together with the air to be drawn in, i.e., to the lower portion of the mist guiding portion 320, and are guided to the discharge port 323. The air guided to the discharge port 323 includes ink mist. When the mist is guided to the discharge port 323 through the air exhaust action by the mist suction pump 350, the mist is collected using the mist removal filter 340. Since moving of the carriage 20 is started thereafter, the ink mist generated by the pre-ejection is not scattered inside the main body of the inkjet printing apparatus. As a result, the amount of ink mist floating in the apparatus can be considerably reduced.

As described above, in this embodiment, when the pre-ejection is performed, ink mist is collected before the moving of the carriage 20 is started. Therefore, the collection of mist generated during the pre-ejection can be performed with the same efficiency as conventionally, when the fan collection mechanism is used that is constantly driven. In addition, since the mist suction pump 350 is driven only the minimum required time in synchronization with the moving of the carriage 20, the noise that accompanies mist collection can be reduced, and a satisfactory usage environment can be maintained. It should be noted that, in this embodiment also, in addition to the mist suction pump 350 provided for the ink receiving member 300, a fan collection mechanism may be employed to remove ink mist that is generated during the printing operation. In this case, although noise is generated by the fan during the printing, since the mist suction pump 350 is employed for pre-ejection, and a special fan is employed for printing, the size of the fan used for printing can be reduced, and accordingly, the noise generated during printing can also be reduced.

### Second Embodiment

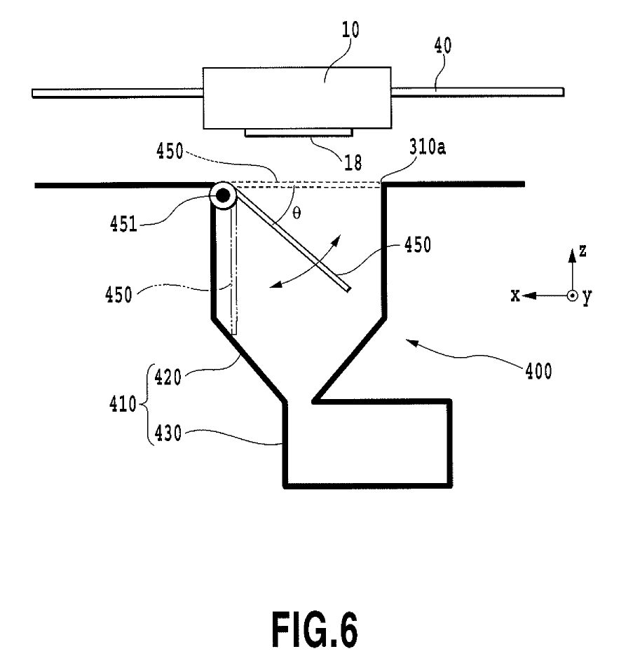

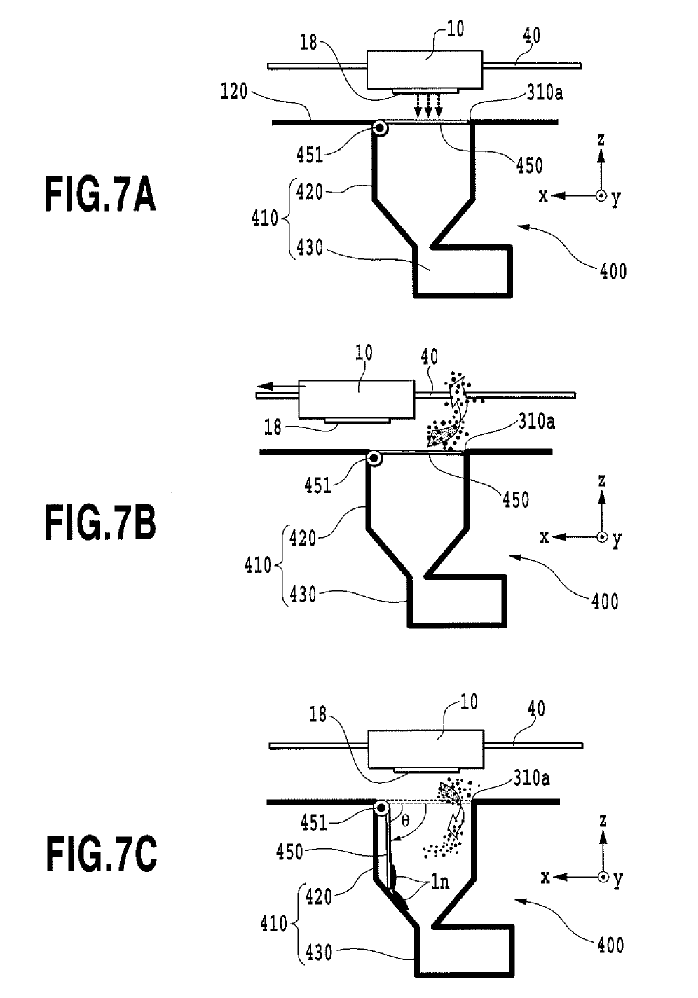

Next, an ink receiving member 400 according to a second embodiment will be described while referring to FIGS. 6 and 7. The arrangement in FIGS. 1 to 3 is also provided for this embodiment. Further, of the ink receiving members provided in correlation with right and left ink receiving openings 310a and 310b, only the ink receiving member 400 for the ink receiving opening 310a is employed in the following explanation.

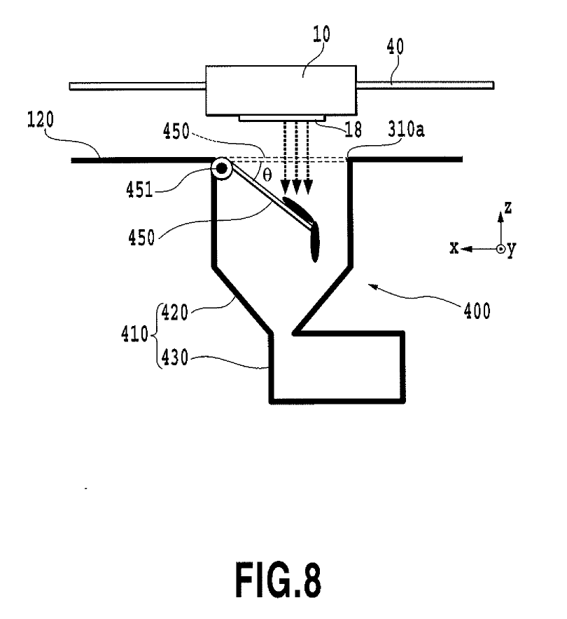

FIGS. 7 and 8 are X-Z cross sectional views of the structure of the ink receiving member 400 for this embodiment.

An ink collecting portion 410 is formed for the ink receiving member 400 of this embodiment, and has the rectangular ink receiving opening 310a as an opening. The ink collecting portion 410 includes: a mist guiding portion 420 that communicates with the ink receiving opening 310a; and a waste ink tank 430 that communicates with the lower end of the mist guiding portion 420. Further, a rotation shaft 451 is rotatably pivoted at the opening of the ink receiving opening 310a, and a movable plate 450 is fixed to the rotation shaft 451, while a torsion spring (not shown) is provided as a elastic member for the rotation shaft 451. This torsion spring constantly maintains an angle (θ) of 90 degrees that is formed by the ink ejection face 18 of the print head 10 and the movable plate 450. Further, a motor (not shown) is arranged to rotate the rotation shaft 451 in a direction opposite the direction in which the rotation shaft 451 is urged by the torsion spring (clockwise in FIG. 7). The movable plate 450 is rectangularly formed, and is twice as long as each side of the ink ejection face 18. The ink receiving opening 310a, which has substantially the same shape as the movable plate 450, is slightly larger than the movable plate 450, so as to prevent it from interfering with the movable plate 450.

The function of the ink receiving member 400 in this embodiment will be described based on the above described structure.

First, the movement of the movable plate 450 for the pre-ejection during printing will be described while referring to FIGS. 7A to 7C.

In the above described process for the pre-ejection during printing, while the carriage 20 is moved, ink droplets are ejected into the ink receiving opening 310a. At this time, the movable plate 450 is held at the position θ=0° by the motor (not shown), i.e., at a position parallel to the ink ejection face 18 in FIG. 7A. In the state θ=0°, the ink ejection face 18 and the movable portion 450 are near each other. And as a result, most of ejected ink droplets land on the movable plate 450 and only a small amount of floating mist occurs.

When the carriage 20 is moved thereafter, the pressure in the space near the rear end of the carriage 20 becomes negative. Thus, mist that failed to land on the movable portion 450, and is floating between the ink ejection face 18 and the movable plate 450, e.g., the area near the ink receiving member 400, are drawn upward by the negative pressure and are scattered through the main body of the printing apparatus, as shown in FIG. 7B. In this embodiment, in order to reduce such scattering of ink mist, the movable plate 450 functions in the following manner.

At the same time as the pre-ejection is terminated in a state wherein, as shown in FIG. 7A, the movable plate 450 is held at the position θ=0°, the movable plate 450 is released by the motor. Thus, through the urging force exerted by the torsion spring, the movable plate 450 is impelled and moved to the position θ=90°. In accordance with the movement, mist floating between the ink ejection face 18 and the movable plate 450, i.e., outside the ink receiving member 400, is drawn to the mist guiding portion 420 from the ink receiving opening 310a, as shown in FIG. 7C. Therefore, when the carriage 20 is moved thereafter, only a considerably small amount of the mist generated during the pre-ejection is scattered through the main body of the printing apparatus. As described above, the movable plate 450 serves as suction means that draws, using suction, air inside the mist guiding portion 420.

This movement of the movable plate 450 will be repeated many times in response to the pre-ejections during the printing operation. Therefore, during printing, through the driving force of the motor, the movable plate 450 is returned from the position θ=90° to the position θ=0° for the next pre-ejection. This return timing is set as the timing for the period immediately prior to the pre-ejection. When the timing immediately prior to the pre-ejection is set for the return of the movable plate 450, the following two effects are obtained. As the first effect, when the mist is drawn into the mist guiding portion 420 by moving the movable plate 450, time can be provided for the mist to be attached to the internal wall of the mist guiding portion 420 or to fall downward along the mist guiding portion 420. Thus, when the movable plate 450 is moved to the position θ=0°, it is possible to prevent the mist drawn into the mist guiding portion 420 once from re-scattering into the outside of the mist guiding portion 420. As the second effect, since the movable plate 450 is held at the position θ=90°, ink in that has settled on the movable plate 450 through the pre-ejection during printing can be discharged downward, and deposition of ink on the top of the movable plate 450 can be prevented. Therefore, when the movable plate 450 is returned to the position θ=0°, the ink ejection face 18 can be prevented from being damaged by ink deposited on the movable plate 450.

It should be noted that the movement of the movable plate 450 arranged for the ink receiving member 400 for the ink receiving opening 310b is controlled in the same manner as for the movable plate 450 that is provided for the ink receiving member 400 for the ink receiving opening 310a.

Sequentially, the movement of the movable plate 450 performed during pre-ejection prior to printing will be described while referring to FIG. 8. In the process for pre-ejection prior to printing, the carriage 20 is halted above the ink receiving opening 310a, and ejects ink onto the movable plate 450. As well as for the pre-ejection during printing, since the movable plate 450 is moved to the position θ=0° by the motor, the amount of mist generated can be reduced. Then, at the same time as the end of the pre-ejection prior to printing, the movable plate 450 is impelled and moved to the position θ=90° by the force exerted by the torsion spring. In accordance with the movement of the movable plate 450, the mist floating between the ink ejection face 18 and the movable plate 450 is led to the ink guiding portion 420. As a result, the scattering of mist through the main body of the printing apparatus can be reduced.

The pre-ejection prior to printing is an operation performed only once before the first printing operation is performed, and the movable plate 450 is maintained at the position θ=90° until the succeeding printing operation and the pre-ejection during printing are performed. Thus, ink on the movable plate 450 falls inside the ink receiving opening 310a.

However, depending on a condition (a printing condition) for the printing operation, it is also effective for the movable plate 450 to be held at a position other than θ=0°, i.e., be held so inclined. The following printing condition is employed when the movable plate 450 being held so inclined is effective: a case wherein the Z axial position of the carriage 20 is low, and the distance between the ink ejection face 18 and the ink receiving opening 310a is extremely short, a case wherein nozzles that eject a large amount of ink are employed, or a case wherein very many ejections are performed. When the movable plate 450 is positioned at θ=0°, in this case, ink that settles on the movable plate 450 might reach the level of the ink ejection face 18 and smudge the face 18. Therefore, as shown in FIG. 8, in this case the movable plate 450 is moved to the position θ=20°, and pre-ejection prior to printing is performed. Thus, since pre-ejection prior to printing can be performed while ink ejected onto the movable plate 450 is discharged downward, the ink deposition problem can be avoided. After the pre-ejection has been completed, the movable plate 450 is moved to the position θ=90°, and ink mist is drawn, together with air, into the lower portion of the mist guiding portion 420. As a result, scattering of the mist through the inside of the printing apparatus can be prevented.

When pre-ejection is to be performed while the movable plate 450 is inclined in the above described manner, the angle θ of the movable plate 450 may be set to one other than 20°. That is, so long as the movable plate 450 can be positioned opposite all the nozzles that can eject ink, and so long as the ink that has landed on the movable plate 450 can fall down, an arbitrary angle for the movable plate 450 can be set for the pre-ejection, and the movable plate 450 can be positioned at a plurality of locations. In addition, the pre-ejection performed while the movable plate is inclined can be applied not only for pre-ejection prior to printing, but also for pre-ejection during printing.

Furthermore, in the above embodiment, a torsion spring has been employed as a elastic member that urges the movable plate 450, as well as the rotation shaft 451. However, a elastic member other than a torsion spring, e.g., a leaf spring or a rubber material, may be employed to urge the movable plate 450.

### Third Embodiment

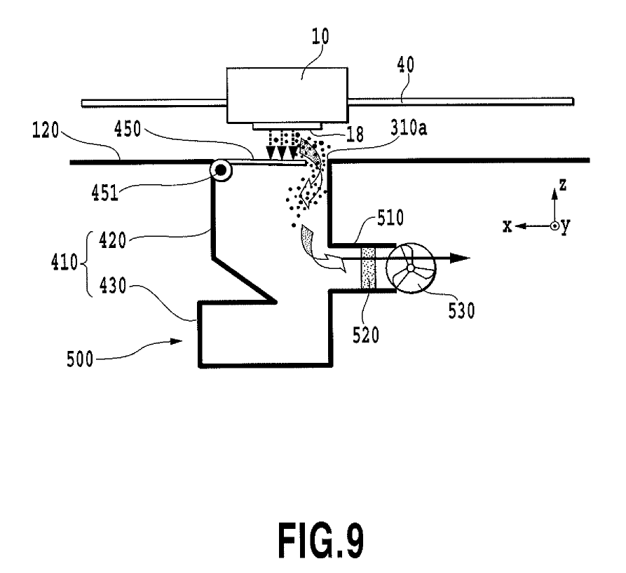

An ink receiving member 500 according to a third embodiment of the present invention will now be described while referring to FIG. 9. FIG. 9 is an X-Z cross sectional view of the peripheral portion of an ink receiving opening 310a for the third embodiment. In FIG. 9, the same reference numerals as used for the second embodiment are provided for portions identical or corresponding to those in the second embodiment, and no further explanation for them will be given.

For this embodiment, the ink receiving member 500 includes: a discharged air passage 510 is formed in the area corresponding to the mist guiding portion 420 of the ink receiving member 400 of the second embodiment; and a mist removable filter 520 and a mist suction fan 530 that are arranged along the discharged air passage 510. A movable plate 450 is a rectangular flat plate, and is twice as long as each side of an ink ejection face 18 of a print head 10. An ink receiving opening 310a is longer by 3 mm than each side of the movable plate 450.

In this embodiment, at the same time, immediately before pre-ejection prior to printing and the pre-ejection during printing are performed, the mist suction fan 530 is driven by an MPU 183. At the pre-ejection time, the movable plate 450 is held at the position θ=0°, and gaps of 1.5 mm and 3 mm are defined between the movable plate 450 and the ink receiving opening 310a. Therefore, through these gaps, air is drawn from a carriage 20 to a mist guiding portion 420. It should be noted that the movement of the movable plate 450 is started after the pre-ejection process has been completed, as well as in the second embodiment.

As described above, since the air suction operation is performed using the mist suction fan 530, ink mist that did not land on the movable plate 450 during the pre-ejection process can be drawn through the gaps and collected by the mist removable filter 520. Furthermore, after the pre-ejection has been completed, the movable plate 450 serving as the suction means is operated to draw ink mist into the ink collecting portion 410, so that the ink mist can be collected more efficiently.

The mist suction fan 530 may be constantly driven. According to the arrangement of this embodiment, since the scattering of the mist that is accompanied by the movement of the carriage can be prevented by a strong drawing air flow generated by the movement of the moving plate 450, the air flow produced by the fan may be weak. In this case, the noise generated is not excessive, even when the fan is operated constantly.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-338697, filed Dec. 15, 2006, which is hereby incorporated by reference herein in its entirety.

What is claimed is:

1. An inkjet printing apparatus, which reciprocally supports a printing unit and which, to perform printing, permits the printing unit to eject ink onto a printing area where a printing medium is held, comprising:
an ink receiving member that receives, at a position not opposite the printing area, ink that is ejected by the printing unit; and
a suction unit for drawing in air around the ink receiving member into ink receiving member,
wherein the suction unit begins a suction operation within a period following the start, by the printing unit, of an ink ejection operation for the ink receiving member, until the start of moving the printing unit from the ink receiving member.

2. An inkjet printing apparatus according to claim 1,
wherein the ink receiving member includes
an opening formed at a position so as to be opposite an ink ejection orifice of the printing unit, and
an ink collecting portion that communicates with the opening; and
wherein the suction unit draws in air outside the ink receiving member through the opening into the ink collecting portion to draw in ink mist which is generated around the ink receiving member when ink is ejected by the printing unit into the ink collecting portion.

3. An inkjet printing apparatus according to claim 2, wherein the suction unit is a pump that draws, through suction, air inside the ink collecting portion.

4. An inkjet printing apparatus according to claim 2, wherein the suction unit is a fan that externally discharges air in the ink collecting portion.

5. An inkjet printing apparatus according to claim 2,
wherein the suction unit includes a movable portion that can be moved into the ink collecting portion from a position for receiving ink that is ejected into the ink receiving member by the printing unit; and
wherein, after the printing unit has ejected ink into the ink receiving member, and before the printing unit is moved away from the ink receiving member, the movable portion is moved into the ink collecting portion, and draws ink out of the ink collecting portion through the opening in the ink collecting portion.

6. An inkjet printing apparatus according to claim 5, wherein, when the printing unit ejects ink into the ink receiving member, the movable portion is held at a position parallel to the ink ejection orifice of the printing unit so as to receive the ink ejected by the printing unit.

7. An inkjet printing apparatus according to claim 5, wherein, when the printing unit ejects ink into the ink receiving member, the movable portion is held in an inclined position relative to the ink ejection orifice of the printing unit, and receives ink ejected by the printing unit.

8. An inkjet printing apparatus according to claim 5, wherein a plurality of positions are available to be designated for the movable plate when the printing unit ejects ink into the ink receiving member.

9. An inkjet printing apparatus according to claim 5, wherein the movable portion is held at a position, against an urging force exerted by a elastic member, so as to be opposite the printing unit, and when the movable portion is released, the movable portion is moved into the ink collecting portion by the urging force exerted by the elastic member.

10. A control method, for an inkjet printing apparatus that reciprocally supports a printing unit and, to perform printing, permits the printing unit to eject ink onto a printing area where a printing medium is held, comprising the steps of:
providing an ink receiving member that accepts, at a position not opposite the printing area, ink that is ejected by the printing unit; and
within a period following the start of an ink ejection operation, by the printing unit, for the ink receiving member until the start of moving the printing unit from the ink receiving member, beginning an operation for drawing in air around the ink receiving member, and collecting, in the ink receiving member, an ink mist generated around the ink receiving member due to the ink ejection operation.
